(19) United States
(12) Patent Application Publication
(10) Pub. No.: US 2004/0128836 A1
(43) Pub. Date: Jul. 8, 2004

(54) RoofmatesTM shinglesawTM

(76) Inventor: Robert Garrett, Severn, MD (US)

Correspondence Address: Robert Platt Bell, Registered Patent Attorney, 8033 Washington Road, Alexandria, VA, 22308, US

(21) Appl. No.: 10/691,967

(22) Filed: Oct. 24, 2003

Related U.S. Application Data
(63) Continuation-in-part of application No. 10/388,642, filed on Mar. 17, 2003.
(63) Continuation-in-part of application No. 10/050,964, filed on Jan. 22, 2002.
(60) Provisional application No. 60/365,538, filed on Mar. 20, 2002.
(60) Provisional application No. 60/426,808, filed on Nov. 18, 2002.
(60) Provisional application No. 60/262,650, filed on Jan. 22, 2001.
(60) Provisional application No. 60/286,527, filed on Apr. 27, 2001.
(60) Provisional application No. 60/297,530, filed on Jun. 13, 2001.
(60) Provisional application No. 60/304,098, filed on Jul. 11, 2001.

(51) Int. Cl. B27B 5/29

(52) U.S. Cl. 30/166.3

(57) ABSTRACT

In one embodiment of the present invention, SHINGLESAW™, comprises a pneumatically powered miniaturized reciprocating or circular saw designed especially for roofing applications. In an alternative embodiment, SHINGLESAW™ may be powered by rechargeable battery packs or the like. SHINGLESAW™ is the size and shape of a Prior Art razor knife, but is powered and provided with a depth gauge to prevent cutting through roofing underlayment or the like.

### CROSS-REFERENCE TO RELATED APPLICATIONS

The present application is a Continuation-in-Part of U.S. patent application Ser. No. 10/388,642, filed on Mar. 17, 2003, and incorporated herein by reference, which in turn claims priority from Provisional U.S. Patent Application No. 60/365,538, filed on Mar. 20, 2002, and incorporated herein by reference.

Parent application Ser. No. 10/388,642, filed Mar. 17, 2003 also claims priority from Provisional U.S. Patent Application No. 60/426,808, filed on Nov. 18, 2002, and incorporated herein by reference.

Parent application Ser. No. 10/388,642, filed Mar. 17, 2003 is also a Continuation-In-Part of U.S. patent application Ser. No. 10/050,964, filed on Jan. 22, 2002, and incorporated herein by reference; that application claims priority from the following Provisional Patent Applications, all of which are incorporated herein by reference: Provisional U.S. Patent Application No. 60/262,650, filed on Jan. 22, 2001; Provisional U.S. Patent Application No. 60/286,527, filed on Apr. 27, 2001; Provisional U.S. Patent Application No. 60/297,530, filed on Jun. 13, 2001; and Provisional U.S. Patent Application No. 60/304,098, filed on Jul. 11, 2001.

### FIELD OF THE INVENTION

The present invention relates to the field of residential and commercial roofing. In particular, the present application is also directed toward an air-powered saw for use in cutting shingles for ridgelines and the like.

### BACKGROUND OF THE INVENTION

When installing roofing materials, it is often necessary to cut shingles either before installation, or in situ. For example, when building a roof “Valley”, shingles may be installed over the valley, and then later cut to the valley “V” shape. In addition, when finishing a roof, it is often necessary to cut the shingles along the edge of the roof to provide a uniform appearing edge. These shingles may be 3 or more layers thick in some places, dulling traditional knives and saws quickly.

Traditionally, a knife has been used for such cuts. However, there is little precision in depth of cut with a knife, and in addition, such a cut can be laborious and difficult. Too deep a cut may create roof leaks. Power saws and the like are difficult to use as the saw may require an extension cord on the roof and also the blade may not be well suited for cutting shingles (i.e., it will “load up” with tar and other materials and cease to cut well). In addition, large power tools present a hazard to workers below if they fall off the roof. What is needed is a small powered tool which can cut shingles accurately and cleanly.

### SUMMARY OF THE INVENTION

In one embodiment of the present invention, SHINGLESAW™, comprises a pneumatically powered miniaturized reciprocating or circular saw designed especially for roofing applications. In an alternative embodiment, SHINGLESAW™ may be powered by rechargeable battery packs or the like. SHINGLESAW™ is the size and shape of a Prior Art razor knife, but is powered and provided with a depth gauge to prevent cutting through roofing underlayment or the like.

### BRIEF DESCRIPTION OF THE DRAWINGS

FIG. 1 is a side view of a pneumatic powered roof shingle cutting tool of the present invention.

FIG. 2 is a side view of a pneumatic powered roof shingle cutting tool (SHINGLESAW™) of the present invention.

FIG. 3 is a side view of a pneumatic powered roof shingle cutting tool or SHINGLESAW™ of the present invention.

FIG. 4 is a front perspective view of another embodiment of the SHINGLESAW™ of the present invention.

FIG. 5 is a rear perspective view of another embodiment of the SHINGLESAW™ of the present invention.

FIG. 6 is a side view of a blade design for the SHINGLESAW™ of the present invention.

FIG. 7 is a side view of a second blade design for the SHINGLESAW™ of the present invention.

FIG. 8 is a side view of a third blade design for the SHINGLESAW™ of the present invention.

FIG. 9 is an enlarged perspective view of a blade tooth design for the SHINGLESAW™ of the present invention.

FIG. 10 is a side view of another embodiment of the SHINGLESAW™ of the present invention.

FIG. 11 is a perspective view of another embodiment of the SHINGLESAW™ of the present invention.

FIG. 12 is a side view of another embodiment of the SHINGLESAW™ of FIG. 11.

FIG. 13 is a side view of another embodiment of a saw blade for the rotary version of the SHINGLESAW™ of the present invention.

FIG. 14 is a side view of another embodiment of a saw blade for the rotary version of the SHINGLESAW™ of the present invention.

FIG. 15 is a side view of another embodiment of a saw blade for the rotary version of the SHINGLESAW™ of the present invention.

FIG. 16 is a side view of another embodiment of a saw blade for the rotary version of the SHINGLESAW™ of the present invention.

FIG. 17 is a side view of another embodiment of a saw blade for the rotary version of the SHINGLESAW™ of the present invention.

FIG. 18 is a side view of another embodiment of a saw blade for the reciprocating version of the SHINGLESAW™ of the present invention.

FIG. 19 is a side view of another embodiment of a saw blade for the reciprocating version of the SHINGLESAW™ of the present invention.

FIG. 20 is a side view of another embodiment of a saw blade for the reciprocating version of the SHINGLESAW™ of the present invention.

FIG. 21 is a side view of another embodiment of a saw blade for the reciprocating version of the SHINGLESAW™ of the present invention.

FIG. 22 is a side view of another embodiment of a saw blade for the reciprocating version of the SHINGLESAW™ of the present invention.

FIG. 23 is a side view of another embodiment of the reciprocating version of the SHINGLESAW™ of the present invention known as AIR KNIFE™.

FIG. 24 is a side view of the embodiment of the reciprocating version of the SHINGLESAW™ of the present invention known as AIR KNIFE™ of FIG. 24 illustrating a cutting angle.

FIG. 25 is a side view of another embodiment of the reciprocating version of the SHINGLESAW™ of the present invention known as AIR KNIFE™ illustrating the angled blade which corrects for the angled cut situation of FIG. 24.

FIG. 26 is a side view of the angled blade of the reciprocating version of the SHINGLESAW™ of the present invention known as AIR KNIFE™ of FIG. 25.

### DETAILED DESCRIPTION OF THE INVENTION

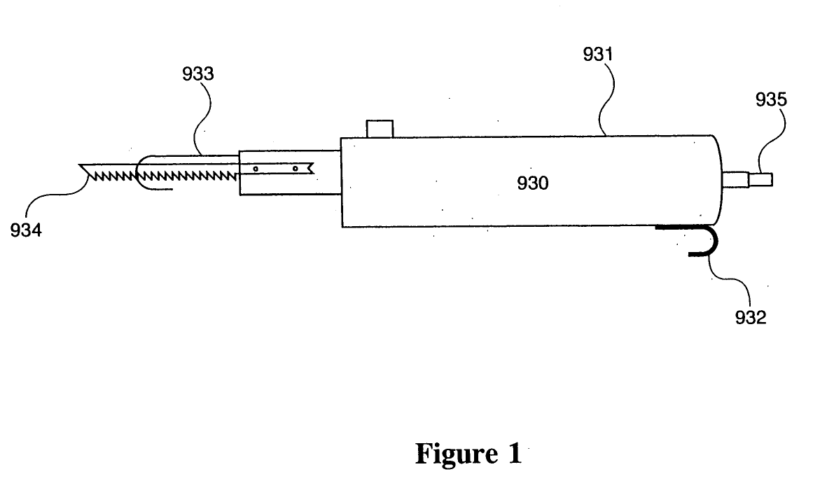

FIG. 1 is a side view of a pneumatic powered roof shingle cutting tool of the present invention. When installing roofing materials, it is often necessary to cut shingles either before installation, or in situ. For example, when building a roof “Valley”, shingles may be installed over the valley, and then later cut to the valley “V” shape. Traditionally, a knife has been used for such cuts. However, there is little precision in depth of cut with a knife, and in addition, such a cut can be laborious and difficult. Too deep a cut may create roof leaks.

Power tools are generally not well suited to cutting shingles. Most are heavy and require electrical power. In addition, large power tools present a hazard to workers below if they fall off the roof. What is needed is a small powered tool which can cut shingles accurately and cleanly. The SHINGLESAW™ 930 of FIG. 1 is, in the preferred embodiment, a pneumatically powered miniaturized reciprocating saw designed especially for roofing applications. In an alternative embodiment, SHINGLESAW™ 930 may be powered by rechargeable battery packs or the like.

SHINGLESAW™ 930 may be provided with a cutting blade 932 of approximately 2″ in length. SHINGLESAW™ 930 may be sized to fit in one hand, much as a prior art razor knife is designed to fit. Adjustable depth gauge 933 may be adjusted to control depth of cut and prevent blade 932 for piercing underlayment or the like. A hook 932 may be provided to allow SHINGLESAW™ to be clipped to a belt or the like. Air chuck 935 allows SHINGLESAW™ to be connected to an air line (such as used for roofing nail guns or the like).

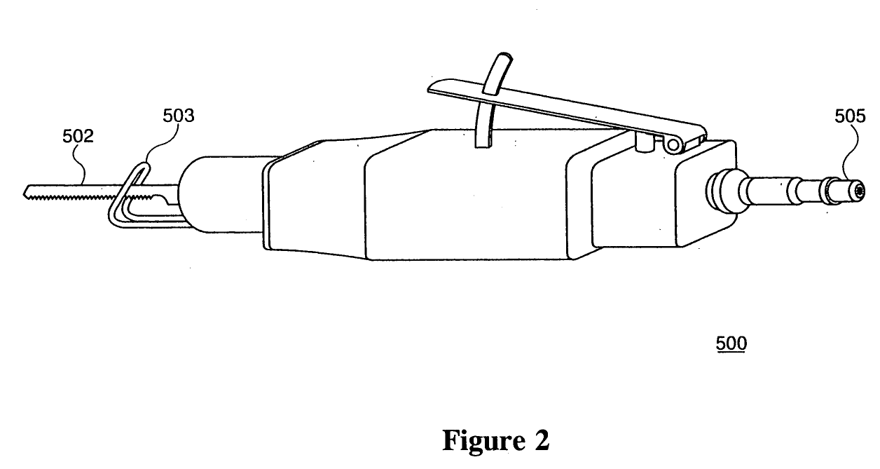

The SHINGLESAW™ 500 of FIG. 2 is, in the preferred embodiment, a pneumatically powered miniaturized reciprocating saw designed especially for roofing applications. In an alternative embodiment, SHINGLESAW™ 500 may be powered by rechargeable battery packs or the like.

SHINGLESAW™ 500 may be provided with a cutting blade 502 of approximately 2″ in length. SHINGLESAW™ 500 may be sized to fit in one hand, much as a prior art razor knife is designed to fit. Adjustable depth gauge 503 may be adjusted to control depth of cut and prevent blade 502 for piercing underlayment or the like. Air chuck 505 allows SHINGLESAW™ to be connected to an air line (such as used for roofing nail guns or the like).

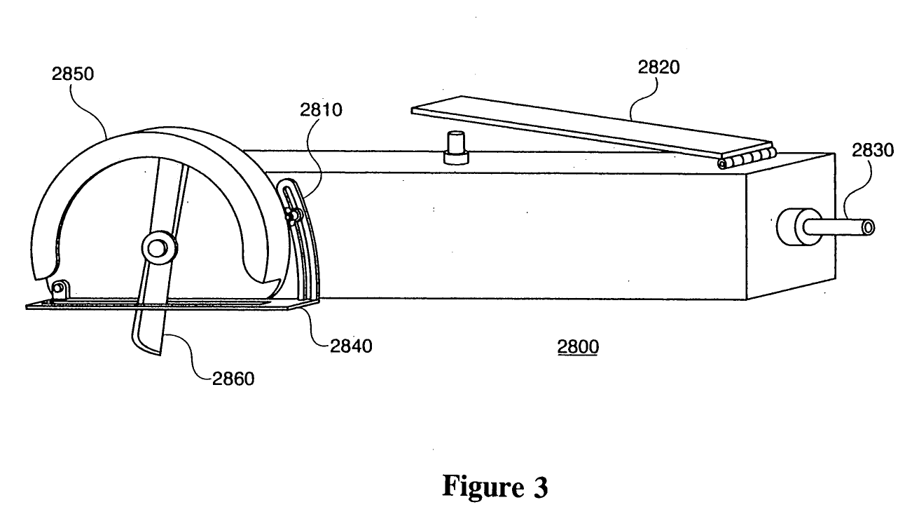

FIG. 3 is a side view of a pneumatic powered roof shingle cutting tool or SHINGLESAW™ of the present invention. The SHINGLESAW™ 2800 of FIG. 3 is, in the preferred embodiment, a pneumatically powered miniaturized rotary saw designed especially for roofing applications. In an alternative embodiment, SHINGLESAW™ 2800 may be powered by rechargeable battery packs or the like.

SHINGLESAW™ 2800 may be provided with a rotary double-edged cutting blade 2860 of approximately 2″ in length. Other numbers of edges may also be used (e.g., four edges). In another embodiment, removable carbide blade inserts may be provided on blade element 2860. Such carbide blade inserts may be held in place by set-screw, clip, or the like. Carbide provides the necessary hardness to withstand the abrasive environment of shingle-cutting, as the asphalt and abrasive grit of shingles may wear down a regular steel blade rapidly.

SHINGLESAW™ 2800 may be sized to fit in one hand, much as a prior art razor knife is designed to fit. Adjustable depth gauge 2840 may be adjusted via wing nut 2810 to control depth of cut and prevent blade 2860 from piercing underlayment or the like. A safety guard 2850, similar to that of a circular saw, only suitably miniaturized, may be provided to protect the user. Air chuck 2830 allows SHINGLESAW™ to be connected to an air line (such as used for roofing nail guns or the like). Lever 2820 may activate an air switch to activate the pneumatic actuator of SHINGLESAW™ 2800.

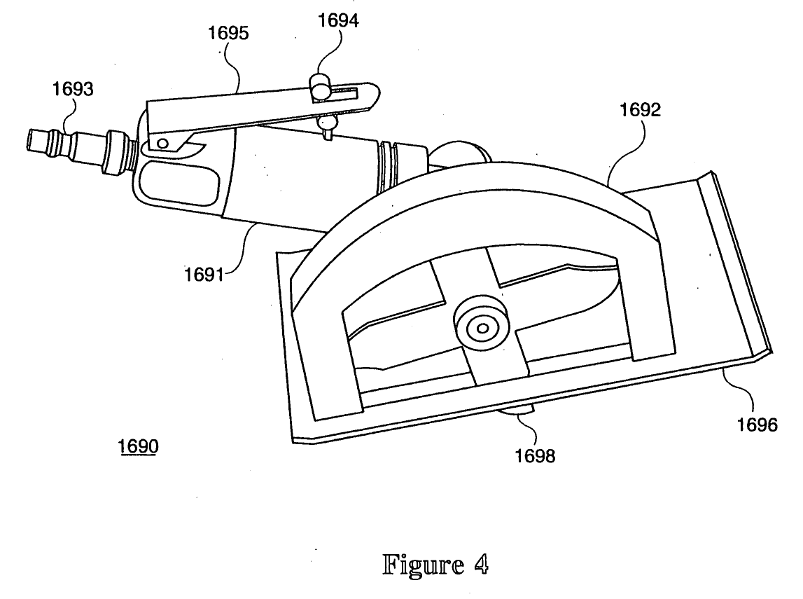

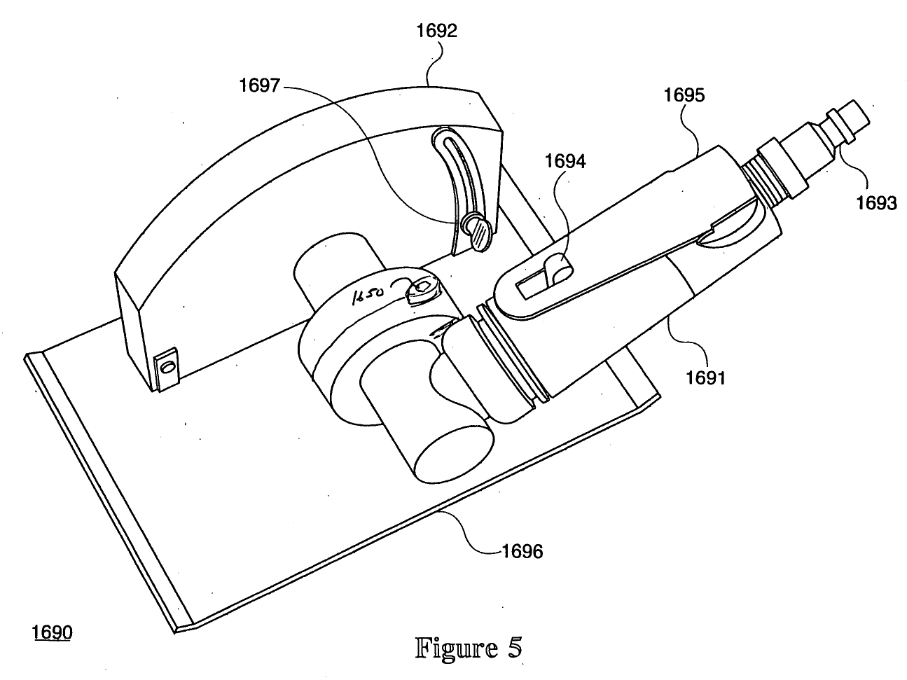

FIG. 4 is a front perspective view of another embodiment of the SHINGLESAW™ of the present invention. FIG. 5 is a rear perspective view of another embodiment of the SHINGLESAW™ of the present invention. This embodiment of SHINGLESAW™ illustrates the first production model to be marketed by the assignee of the present invention, A Prior Art angle grinder airmotor 1691 is provided with a saw housing assembly 1692 formed of anodized aluminum, clamped to the output portion of the airmotor via clamp 1650. The housing assembly 1692 may be coated with Teflon to reduce buildup of tar and other roofing material cutting detritus

The airmotor may be provided with a quickconnect 1693 to allow it to be connected to an air line such as used by a roofer for a nailgun or the like. A safety 1694 may be provided to the lever switch 1695 to prevent a user from accidentally activating the SHINGLESAW™ 1690. The blade housing and guard 1692 may be pivotally mounted to the shoe plate 1696 by means of an adjustable wingnut 1697 so as to allow for depth control of the cut. Note the four bladed saw 1698 in FIG. 4, with each blade provided with a carbide tip (not shown).

SHINGLESAW™ unlike Prior Art circular saws and the like, is small enough to fit in roof valleys and other tight areas where larger saws will not fit. Unlike rechargeable battery-powered saws, the SHINGLESAW™ in the embodiment of FIG. 4, uses air power, and thus has the power and capacity for extended work.

SINGLESAW™ may also be provided with a cutting guide attached to the underside of shoe plate 1696, behind blade 1698 to act as a cutting guide in a similar manner to a rip fence on a circular saw, but to make flush cuts such as on the edge of a roof, such that the saw blade will cut flush with the drip edge without the saw blade cutting the drip edge itself.

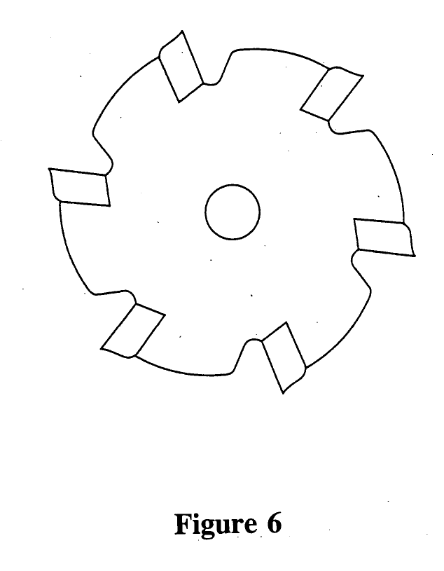

FIG. 6 is a side view of a blade design for the SHINGLESAW™ of the present invention. In this design, six blade tips are provided, each with a carbide insert. The shape of the blade is designed to prevent the blade from “loading up” with roofing tar and debris. The blade in the preferred embodiment is 3⅜″ in diameter, but may also be made in 4″, 6″ and even standard circular saw sizes (e.g., 7.22″ or the like). However, in the preferred embodiment the saw blade is made smaller to keep the overall tool size compact and also to allow the low-torque air motor sufficient leverage to cut the shingles.

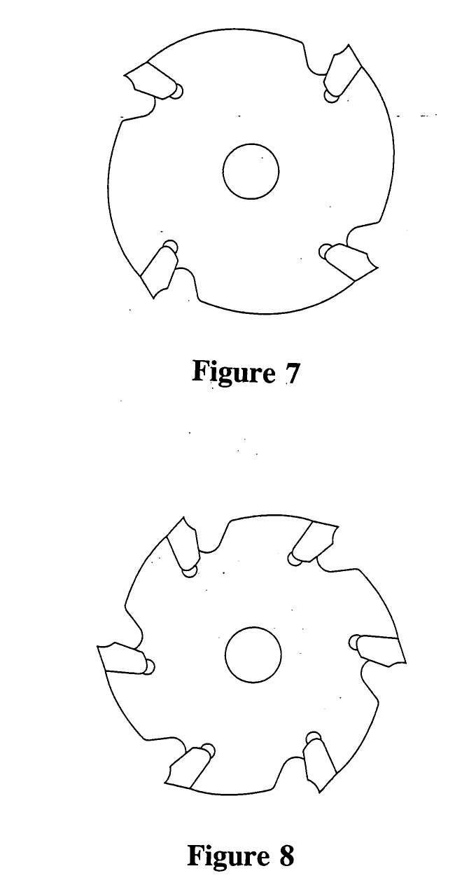

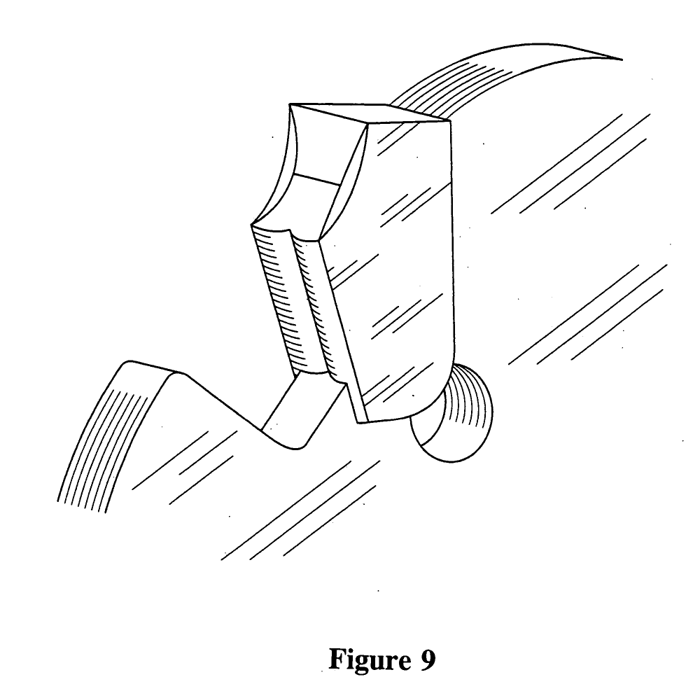

FIG. 7 is a side view of a second blade design for the SHINGLESAW™ of the present invention. FIG. 8 is a side view of a third blade design for the SHINGLESAW™ of the present invention. In these designs, which may have the same diameters as the saw blade discussed above, are provided with a “chipper” design carbide insert. FIG. 9 is an enlarged perspective view of a blade tooth design for the SHINGLESAW™ of the present invention illustrating this chipper design. This chipper design saw blade tooth helps prevent buildup of tar and other roofing debris on the saw blade.

Different blade and blade teeth designs may be employed to cut different types of materials such as wood, metal, or the like. While disclosed in the preferred embodiment as cutting shingle materials, the SHINGLESAW™ may be used to cut other materials. Unlike Prior Art circular saw blades, which are designed to make thin cuts, the SHINGLESAW™ blade is approximately ¼″ thick to make a wide cut without binding in the cut material. Experiments with Prior Art circular saw blades shows these blades to bind when cutting through several layers of roofing material.

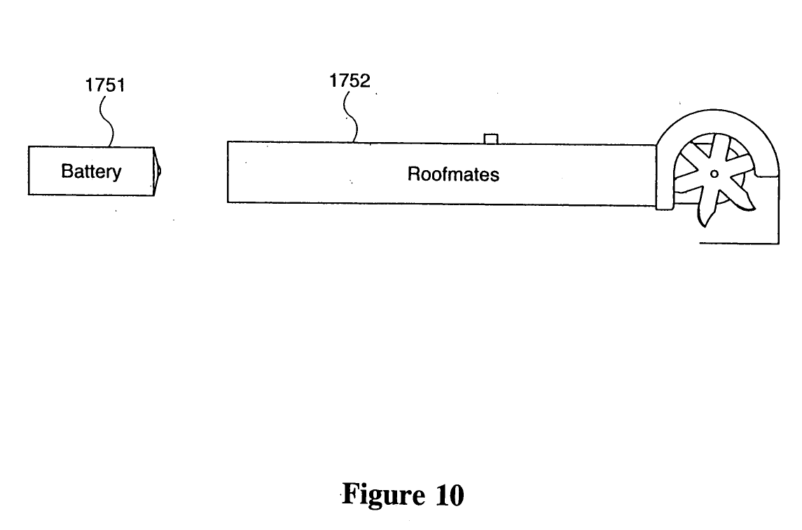

FIG. 10 is a side view of another embodiment of the SHINGLESAW™ of the present invention. In this embodiment, a rechargeable battery 1751 is provided to run the saw. Rechargeable battery powered saws are known in the art. The saw 1752 of FIG. 175 may be provided with the unique blade design of the present invention. In addition, the saw 1752 of FIG. 175 may be designed to run on tubular rechargeable batteries 1751 known in the art.

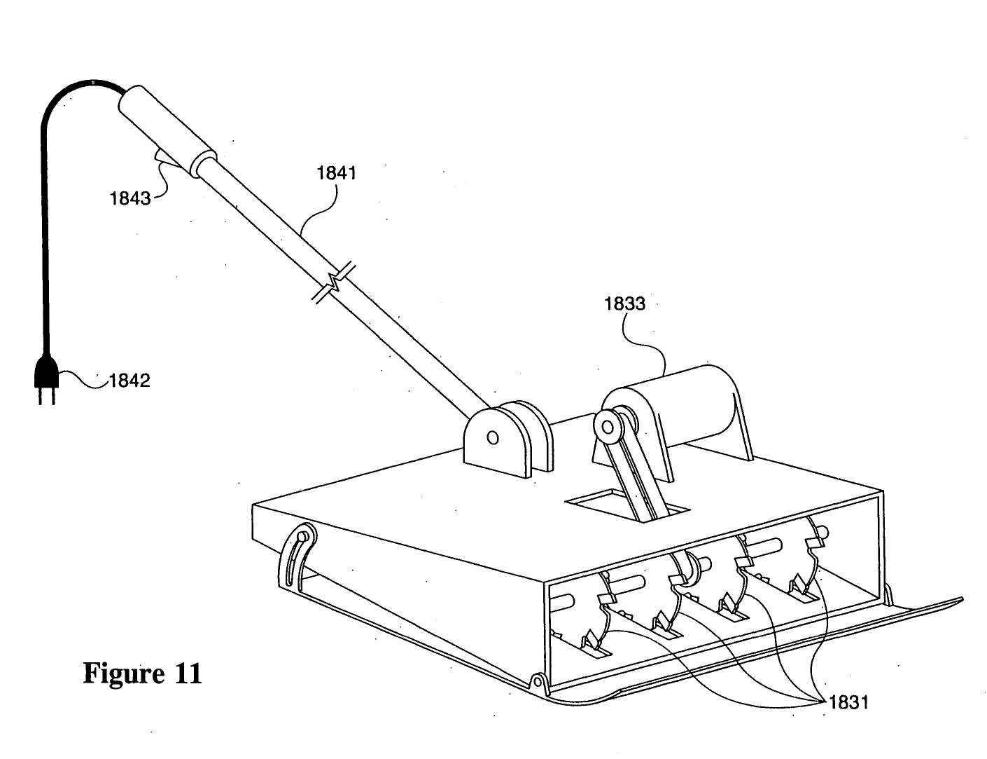

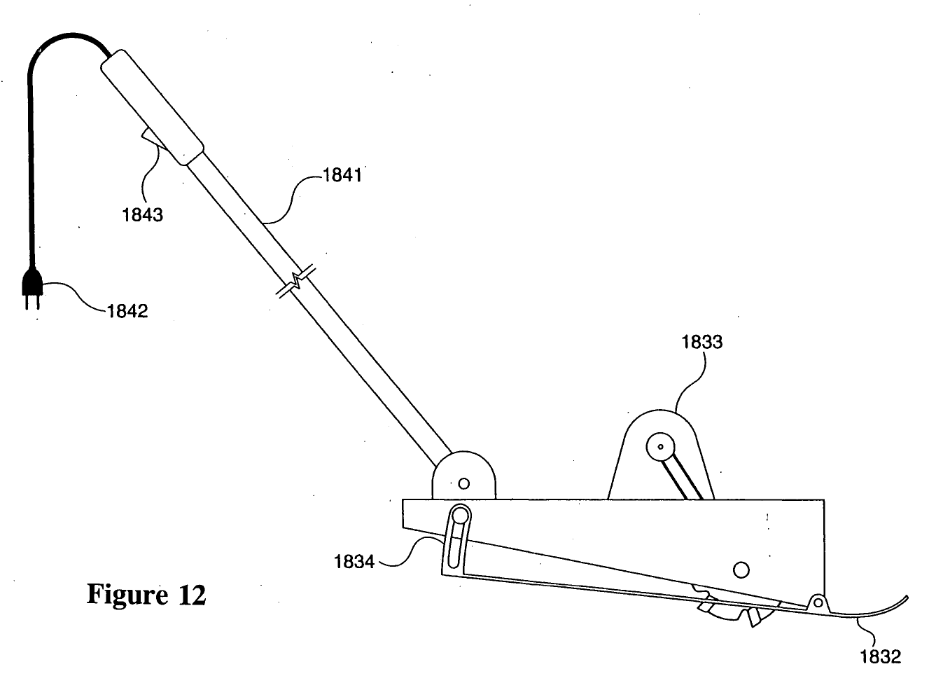

FIG. 11 is a perspective view of another embodiment of the SHINGLESAW™ of the present invention. FIG. 12 is a side view of another embodiment of the SHINGLESAW™ of FIG. 11. This embodiment of the SHINGLESAW™ is designed to cut up existing shingles prior to their removal. In the Prior Art, roofers removed shingles with “roofer's shovels”, shovels with a sharpened saw-tooth edge. By driving a such a shovel up underneath the shingles, the shingle nails could be cut and the shingles removed. However, since the shingles overlap, a portion of adjacent shingles would be pulled up, making the job messy, as shingles and portions of shingles would be removed or partially removed.

The apparatus of FIGS. 11 and 183 solves this problem by providing a plurality of cutting blades 1831 similar to those described above in connection with the other embodiments of SHINGLESAW™. These blades 1831 are arranged in parallel, approximately 6″ apart. When run up and down a roof, this version of SHINGLESAW™ cuts the roof into strips which can then be easily removed with a roofer's shovel.

A depth control 1834 prevents this version of SHINGLESAW™ from cutting into the roof structure and controls depth by adjusting the position of shoe plate 1832. A handle 1841 may be provided with a power cord 1842 and control switch 1843. The apparatus may be powered by an electric motor 1833 or air motor, although in the preferred embodiment an electric motor is used to provide the needed power and torque to drive the multiple saw blades.

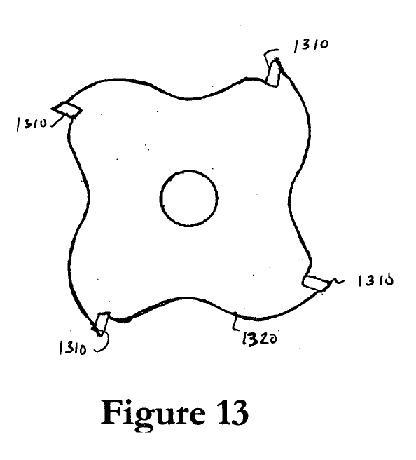

FIG. 13 is a side view of another embodiment of a saw blade for the rotary version of the SHINGLESAW™ of the present invention. This blade is designed to cut shingles including fiber cement shingles, without binding or loading up. Blade 1320 may be provided in any one of a number of sizes, including the smaller sizes discussed above for use with the SHINGLESAW™ of the present invention, and also provided in larger sizes for use with standard circular saws.

To prevent binding, blade 1320 may be Teflon™ coated or coated with another type of non-stick material. Blade 1320 is shaped with a dropoff behind each blade tip element 1310 to prevent loading with roofing material or the like. As most roof shingles contain tar and tar-like elements, when cutting such shingles, tar and cutting debris tends to cling to the blade and cause clogging or binding. By providing a pronounced dropoff behind each blade tip element 1310, such binding and loading is reduced. Blade tip element 1310 may comprise a carbide bit as discussed above, and may include any one of the carbide bit designs disclosed herein or known in the art.

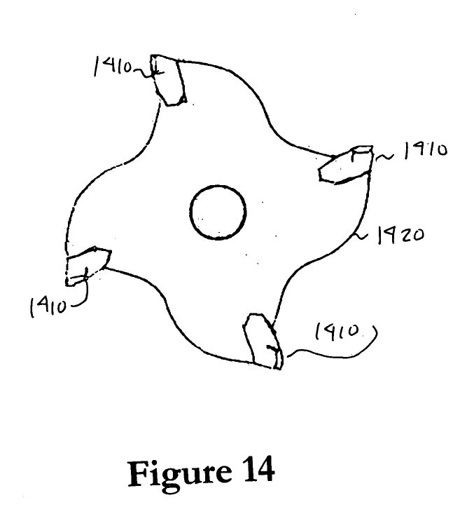

FIG. 14 is a side view of another embodiment of a saw blade for the rotary version of the SHINGLESAW™ of the present invention. In this embodiment, blade 1410 is provided with an even sharper dropoff from the blade tip element 1410 to reduce clogging and the like. Note that blade tip element 1410 is illustrated with a blade tip design similar to or identical to that in FIG. 9.

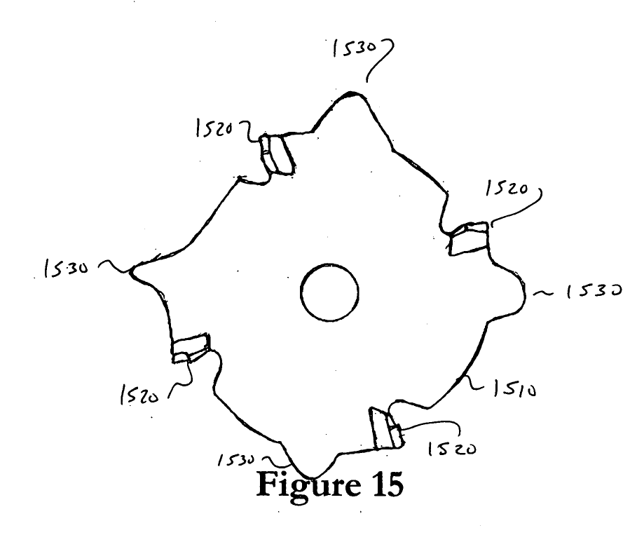

FIG. 15 is a side view of another embodiment of a saw blade for the rotary version of the SHINGLESAW™ of the present invention. In this embodiment, blade 1510 is provided with cut cleaning elements 1530 to remove debris and the like from the cut slot when the saw blade is cutting. Note that in this illustration, the blade should appear symmetrical, and moreover, cut cleaning elements 1530 are provided at a radius less than or equal to the radius of blade tips 1520, such that they ride in the cut groove at a depth slightly less than blade tips 1520. When cutting shingles, tar and shingle debris tends to clog the cutting slot, causing binding and uneven cutting. This blade design helps reduce this problem by ejecting cut material from the cut slot, allowing for more even cutting and less binding.

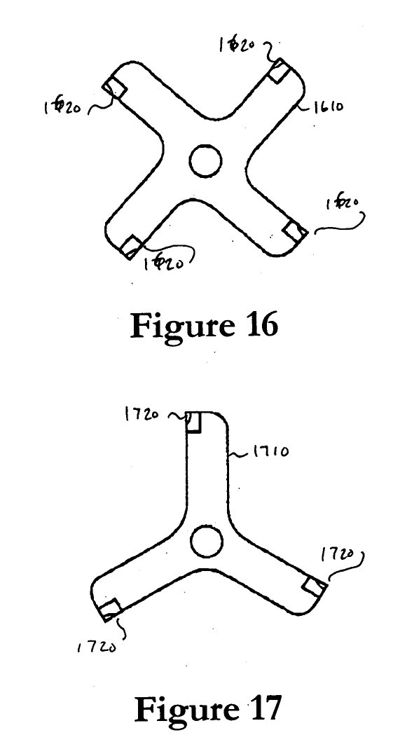

FIG. 16 is a side view of another embodiment of a saw blade for the rotary version of the SHINGLESAW™ of the present invention. In this embodiment, a four-bladed blade 1610 design is used with carbide tips. The use of the four thin blades helps prevent buildup of tar and the like and also allows for ejection of material. Again, carbide tips 1720 according to any of the designs illustrated herein or known in the art may be applied.

FIG. 17 is a side view of another embodiment of a saw blade for the rotary version of the SHINGLESAW™ of the present invention. Similar to FIG. 16, this design uses three thin blades 1710, and may be more useful at higher rpms than the four-bladed design of FIG. 16. Carbide tips 1720 may comprise any of the carbide tips designs illustrated herein or known in the art.

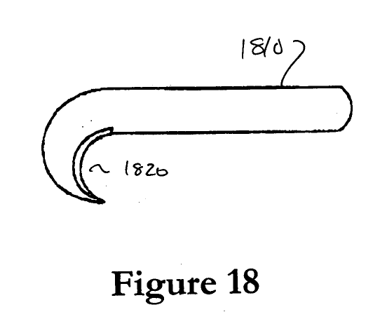

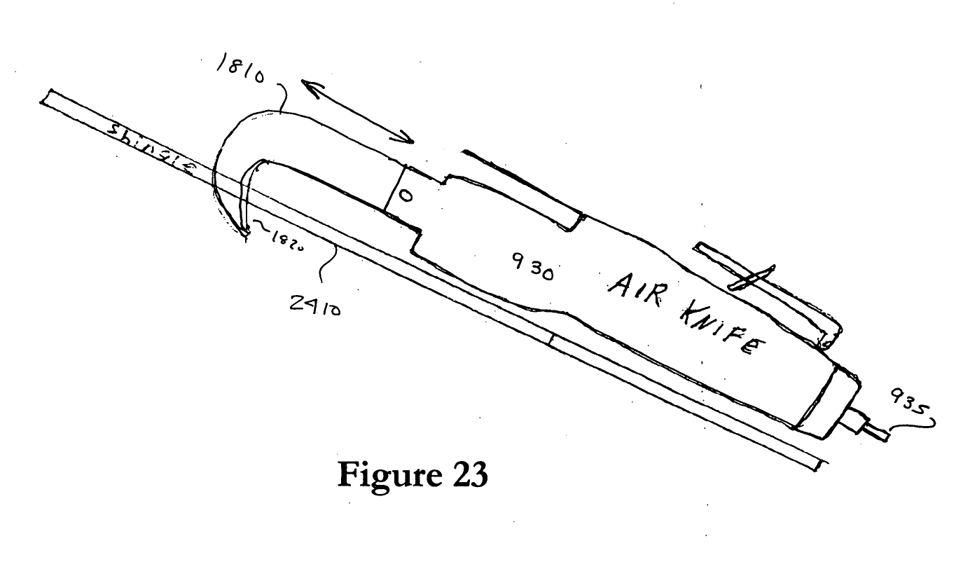

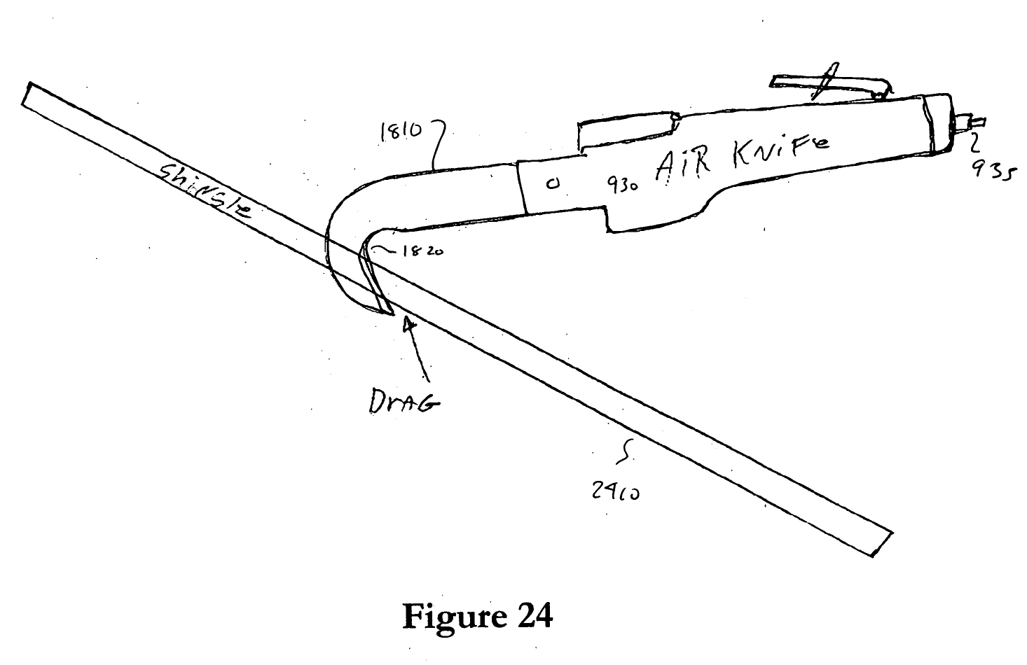

FIG. 18 is a side view of another embodiment of a saw blade for the reciprocating version of the SHINGLESAW™ of the present invention. This blade 1810 may be used, e.g., with the reciprocating air motor of FIGS. 1 and 2, or with an electric reciprocating saw (e.g., SAWZALL™) or the like. The blade may be made from hardened tool steel, mild steel, or stainless steel and may be sharpened 1820 to a fine edge. The use of this blade will be described in more detail in conjunction with FIGS. 23 and 24.

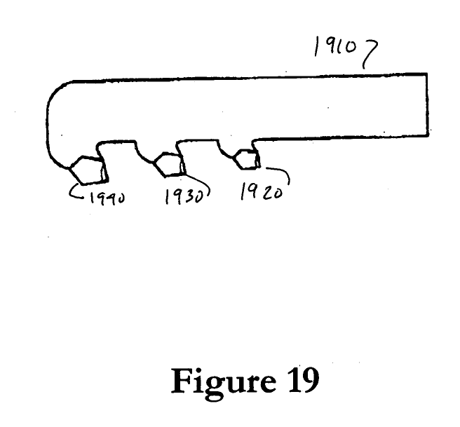

FIG. 19 is a side view of another embodiment of a saw blade for the reciprocating version of the SHINGLESAW™ of the present invention. This blade 1910 may be used, e.g., with the reciprocating air motor of FIGS. 1 and 2, or with an electric reciprocating saw (e.g., SAWZALL™) or the like. The blade may be made from hardened tool steel, mild steel, or stainless steel and may be provided with carbide inserts 1920, 1930, and 1940. The use of this type blade will be described in more detail in conjunction with FIGS. 23 and 24. The number of carbide inserts may be varied without departing from the spirit and scope of the present invention. Note that each insert 1920, 1930, and 1940 is located at a greater depth than its predecessor. This staggered depth arrangement is designed to avoid digging and binding of the blade. Carbide blade tips 1920, 1930, and 1940 may comprise any of the carbide blade tip designs disclosed herein or known in the art.

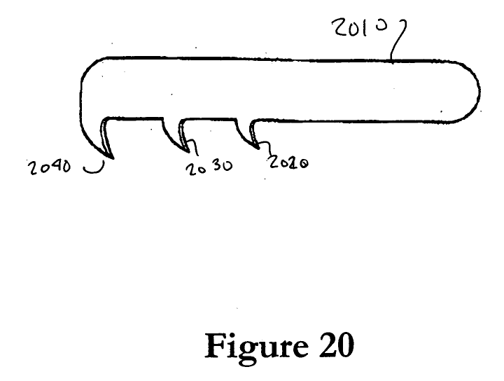

FIG. 20 is a side view of another embodiment of a saw blade for the reciprocating version of the SHINGLESAW™ of the present invention. This blade 2010 may be used, e.g., with the reciprocating air motor of FIGS. 1 and 2, or with an electric reciprocating saw (e.g., SAWZALL™) or the like. The blade may be made from hardened tool steel, mild steel, or stainless steel and may be provided with sharpened blade tips 2020, 2030, and 2040. The use of this type blade will be described in more detail in conjunction with FIGS. 23 and 24. The number of sharpened blade tips may be varied without departing from the spirit and scope of the present invention. Note that each sharpened blade tip 2020, 2030, and 2040 is located at a greater depth than its predecessor. This staggered depth arrangement is designed to avoid digging and binding of the blade.

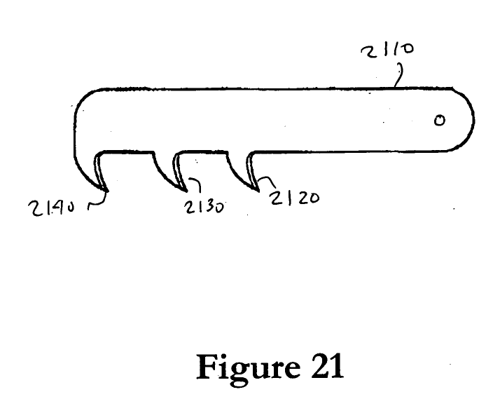

FIG. 21 is a side view of another embodiment of a saw blade for the reciprocating version of the SHINGLESAW™ of the present invention. This blade 2110 may be used, e.g., with the reciprocating air motor of FIGS. 1 and 2, or with an electric reciprocating saw (e.g., SAWZALL™) or the like. The blade may be made from hardened tool steel, mild steel, or stainless steel and may be provided with sharpened blade tips 2120, 2130, and 2140. The use of this type blade will be described in more detail in conjunction with FIGS. 23 and 24. The number of sharpened blade tips may be varied without departing from the spirit and scope of the present invention. Note that each sharpened blade tip 2120, 2130, and 2140, is at the same depth as its predecessor.

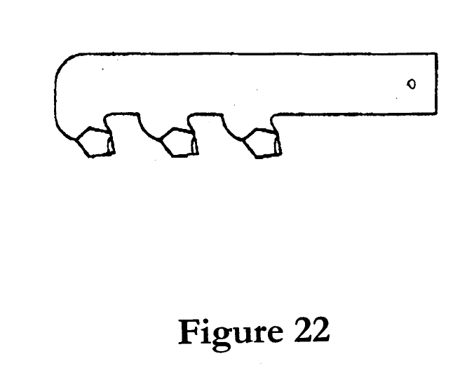

FIG. 22 is a side view of another embodiment of a saw blade for the reciprocating version of the SHINGLESAW™ of the present invention. This blade 2210 may be used, e.g., with the reciprocating air motor of FIGS. 1 and 2, or with an electric reciprocating saw (e.g., SAWZALL™) or the like. The blade may be made from hardened tool steel, mild steel, or stainless steel and may be provided with carbide inserts 2220, 2230, and 2240. The use of this type blade will be described in more detail in conjunction with FIGS. 23 and 24. The number of carbide inserts may be varied without departing from the spirit and scope of the present invention. Note that each carbide insert 2220, 2230, and 2240 is located at the same depth as its predecessor. Carbide blade tips 2220, 2230, and 2240 may comprise any of the carbide blade tip designs disclosed herein or known in the art.

FIG. 23 is a side view of another embodiment of the reciprocating version of the SHINGLESAW™ of the present invention known as AIR KNIFE™. This Figure illustrates how any of the blade designs of FIG. 18 though FIG. 22 may be used to cut a shingle 2410 or shingles on a roof. As illustrated in FIG. 23, the SHINGLESAW™ AIR KNIFE™ 930 may comprise a reciprocating air powered saw as known in the art. Blade 1810 may be attached to AIR KNIFE™ 930 through a chuck, clamp or other device as is known in the art. Note that for purposes of illustration, blade 1810 from FIG. 18 is illustrated here. However any of the blade designs of FIGS. 18-22 may be used without departing from the spirit and scope of the present invention.

In use the user holds the AIR KNIFE™ 930 parallel to the roofing surface (e.g., shingle 2410) to be cut as illustrated in FIG. 23. The reciprocating action of blade 1810 cuts through the roofing surface due to the reciprocating action of the AIR KNIFE™ 930 air motor.

FIG. 24 is a side view of the embodiment of the reciprocating version of the SHINGLESAW™ of the present invention known as AIR KNIFE™ of FIG. 24 illustrating a cutting angle. When in actually use, it may be difficult to hold AIR KNIFE™ at an angle parallel to shingle 2410 as illustrated in FIG. 23. Moreover, such a cutting angle tends to wear on the underside surface of the air motor of AIR KNIFE™ due to the abrasive nature of shingle material. A sole or base plate may be attached to the underside of the AIR KNIFE™ to reduce such wear. The sole may be made from ⅛″ wire stock and may be bent into a loop shape or the like.

Cutting at the angle shown in FIG. 24 places the sharpened blade tip 1820 at a less preferred angle for cutting without binding on the shingle material. And as a result, the blade tip 1820 tends to drag.

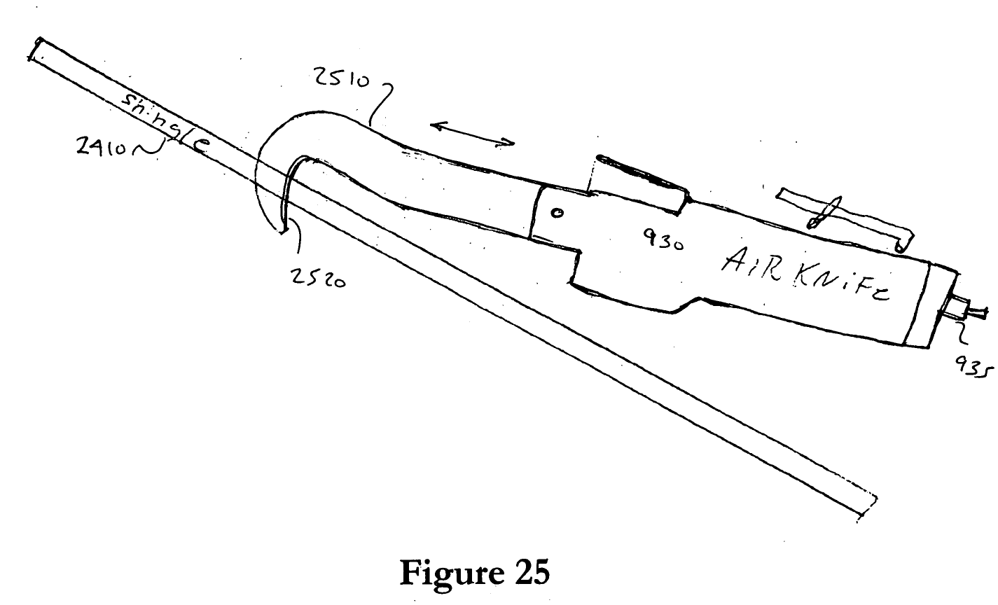

FIG. 25 is a side view of another embodiment of the reciprocating version of the SHINGLESAW™ of the present invention known as AIR KNIFE™ illustrating the angled blade 2510, which corrects for the angled cut situation of FIG. 24. This angled blade 2510, which is the preferred embodiment of the AIR KNIFE™ of the present invention, allows the AIR KNIFE™ 930 to be used at and angle relative to shingle 2410 or other roofing material, while still maintaining an optimal cutting angle with reduced drag.

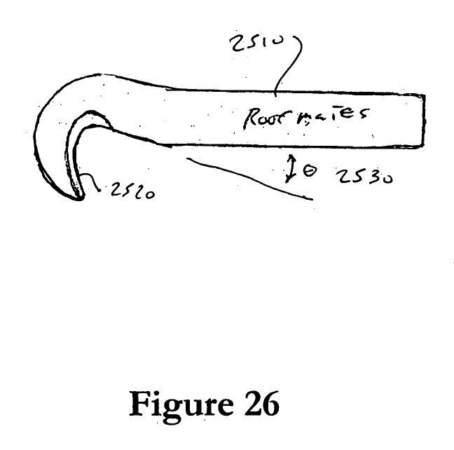

FIG. 26 is a-side view of the angled blade of the reciprocating version of the SHINGLESAW™ of the present invention known as AIR KNIFE™ of FIG. 25. It should be noted that this angled embodiment may be applied to any of the blade designs of FIGS. 18-22 without departing from the spirit and scope of the present invention. In the preferred embodiment, the blade angle 2530 may range from approximately 5 to 30 degrees, although other angles may be used within reason.

While the preferred embodiment and various alternative embodiments of the invention have been disclosed and described in detail herein, it may be apparent to those skilled in the art that various changes in form and detail may be made therein without departing from the spirit and scope thereof.

We claim:

1. A roofer's saw comprising:
an airmotor, for receiving compressed air and driving a rotary shaft;
a sawblade, coupled to the rotary housing, for cutting roofing shingles;
a saw housing, adjustably coupled to the airmotor, for controlling a depth of cut of the sawblade in the roofing shingles.

2. The roofer's saw of claim 1, wherein the blade comprises a rotary saw blade of 3⅜″ to 5″ in diameter having 4 to 8 teeth, each of the 4 to 8 teeth having a carbide bit.

3. The roofer's saw of claim 1, wherein the air motor comprises a 90 degree grinder motor adapted to drive the sawblade.

4. The roofer's saw of claim 3 wherein the air motor further includes an on-off valve, the on-off valve provided with a safety latch to prevent the on-off valve from being actuated unless the safety latch is first released.

5. The roofer's saw of claim 1, wherein the sawblade comprises a four-bladed blade having carbide tips on each blade.

6. The roofer's saw of claim 1, wherein the sawblade comprises a six-bladed blade having carbide tips on each blade.

7. The roofer's saw of claim 1, wherein the sawblade comprises a carbide-tipped sawblade having a chipper edged carbide bit.

8. The roofer's saw of claim 1, wherein the sawblade is approximately ¼″ thick so as to provide a wide cut without binding.

9. The roofer's saw of claim 1, wherein the sawblade is substantially 3⅜″ in diameter so as to cut through multiple layers of shingles without binding.

10. An apparatus for cutting roofing material comprising:
a reciprocating air motor, for receiving compressed air and oscillating a blade chuck; and
a blade, coupled to the reciprocating air motor, for cutting roofing material, the blade comprising a first portion for attaching to the blade chuck, and a cutting portion for cutting the roofing material.

11. The apparatus of claim 10, wherein the cutting portion comprises at least one carbide bit for cutting the roofing material.

12. The apparatus of claim 10, wherein the cutting portion comprises at least one sharpened blade portion, each having a substantially hooked shape.

13. The apparatus of claim 10, wherein the blade further comprises an intermediate portion connecting the first portion and the cutting portion, the intermediate portion having a predetermined angle, such that when the reciprocating air motor is held at a predetermined angle to the roofing material, the cutting portion is provided at an angle substantially normal to a surface of the roofing material.

14. A method of cutting roofing material, comprising the steps of:
cutting the roofing material using a roofer's saw comprising an airmotor, for receiving compressed air and driving a rotary shaft; a sawblade, coupled to the rotary housing, for cutting roofing shingles; and a saw housing, adjustably coupled to the airmotor, for controlling a depth of cut of the sawblade in the roofing shingles.

15. The method of claim 14, wherein the blade comprises a rotary saw blade of 3⅜″ to 5″ in diameter having 4 to 8 teeth, each of the 4 to 8 teeth having a carbide bit.

16. The method of claim 14, wherein the air motor comprises a 90 degree grinder motor adapted to drive the sawblade.

17. The method of claim 16, wherein the air motor further includes an on-off valve, the on-off valve provided with a safety latch to prevent the on-off valve from being actuated unless the safety latch is first released.

18. The method of claim 14, wherein the sawblade comprises a four-bladed blade having carbide tips on each blade.

19. The method of claim 14, wherein the sawblade comprises a six-bladed blade having carbide tips on each blade.

20. The method of claim 14, wherein the sawblade comprises a carbide-tipped sawblade having a chipper edged carbide bit.

21. The method of claim 14, wherein the sawblade is approximately ¼″ thick so as to provide a wide cut without binding.

22. The method of claim 14, wherein the sawblade is substantially 3⅜″ in diameter so as to cut through multiple layers of shingles without binding.

23. A method for cutting roofing material, comprising the step of cutting roofing material using a roofing knife including a reciprocating air motor, for receiving compressed air and oscillating a blade chuck; and a blade, coupled to the reciprocating air motor, for cutting roofing material, the blade comprising a first portion for attaching to the blade chuck, and a cutting portion for cutting the roofing material.

24. The method of claim 23, wherein the cutting portion comprises at least one carbide bit for cutting the roofing material.

25. The method of claim 23, wherein the cutting portion comprises at least one sharpened blade portion, each having a substantially hooked shape.

26. The method of claim 23, wherein the blade further comprises an intermediate portion connecting the first portion and the cutting portion, the intermediate portion having a predetermined angle, such that when the reciprocating air motor is held at a predetermined angle to the roofing material, the cutting portion is provided at an angle substantially normal to a surface of the roofing material.
